(19) United States
(12) Patent Application Publication
(10) Pub. No.: US 2005/0241919 A1
(43) Pub. Date: Nov. 3, 2005

(54) Method and apparatus for securing a floor slat to a drive beam of a moving floor

(76) Inventor: Paul W. Peterson JR., Cary, NC (US)

Correspondence Address: BARNES & THORNBURG, 11 SOUTH MERIDIAN, INDIANAPOLIS, IN, 46204, US

(21) Appl. No.: 10/833,567

(22) Filed: Apr. 28, 2004

(51) Int. Cl. B65G 25/04

(52) U.S. Cl. 198/750.2

(57) ABSTRACT

An apparatus for securing a floor slat as part of a moving floor apparatus includes a clamp assembly which clamps the floor slat. The clamp assembly may include a pair of clamp blocks which clamp the floor slat therebetween. A method of securing a floor slat to a drive beam of a moving floor is also disclosed.

### FIELD OF THE DISCLOSURE

The present disclosure relates generally to moving floors of the type having a number of reciprocating floor slats.

### BACKGROUND

Moving floors are used in trucks and trailers to facilitate the movement of cargo. A moving floor typically has a plurality of reciprocating floor slats which are coupled to a number of drive beams. The drive beams are driven by a drive actuator. The drive actuator typically includes a number of independently-controlled hydraulic cylinders which are operated to move the drive beams (and hence the floor slats) in a predetermined sequence thereby moving the cargo in a desired direction.

### SUMMARY

According to one aspect of the present disclosure, an apparatus for securing a floor slat as part of a moving floor includes a clamp assembly that clamps the floor slat. In certain embodiments, the clamp assembly includes a pair of clamp blocks that clamp the floor slat.

The clamp assembly may also include a fastener which extends in a direction substantially perpendicular to the length of the floor slat. The fastener may be positioned in openings in each of the clamp blocks. In certain embodiments, the fastener may include a bolt extending between the clamp blocks.

The clamp blocks may have a knurled surface which engages the floor slat. In certain embodiments, the floor slat also has one or more knurled surfaces.

The clamp blocks may have a removable insert with the knurled surface defined therein, or may be embodied as a one-piece component.

The knurled surface of the floor slat may be formed on an insert which is secured to the body of the floor slat. Alternatively, the body of the floor slat may be formed with the knurled surface defined therein.

A method of securing a floor slat to a drive beam of a moving floor is also disclosed. The method includes positioning the floor slat between a first clamp block and second clamp block of a clamp assembly. A fastener may be tightened to generate a clamping force which clamps the floor slat in the clamp assembly.

### BRIEF DESCRIPTION OF THE DRAWINGS

The detailed description particularly refers to the accompanying figures in which:

FIG. 1 is a perspective view of a moving floor apparatus, note that a number of the floor slats have been removed for clarity of description;

FIG. 2 is an enlarged fragmentary view showing the clamp assembly of the moving floor apparatus in greater detail;

FIG. 3 is an exploded perspective view of the clamp assembly;

FIG. 4 is a cross sectional view taken along the line 4-4 of FIG. 2, as viewed in the direction of the arrows, note that the fasteners are not shown in cross section for clarity of description; and

FIG. 5 is an enlarged fragmentary perspective view of one of the floor slats of the moving floor apparatus of FIG. 1, note that a portion of the upper deck has been cut away for clarity of description.

### DETAILED DESCRIPTION OF THE DRAWINGS

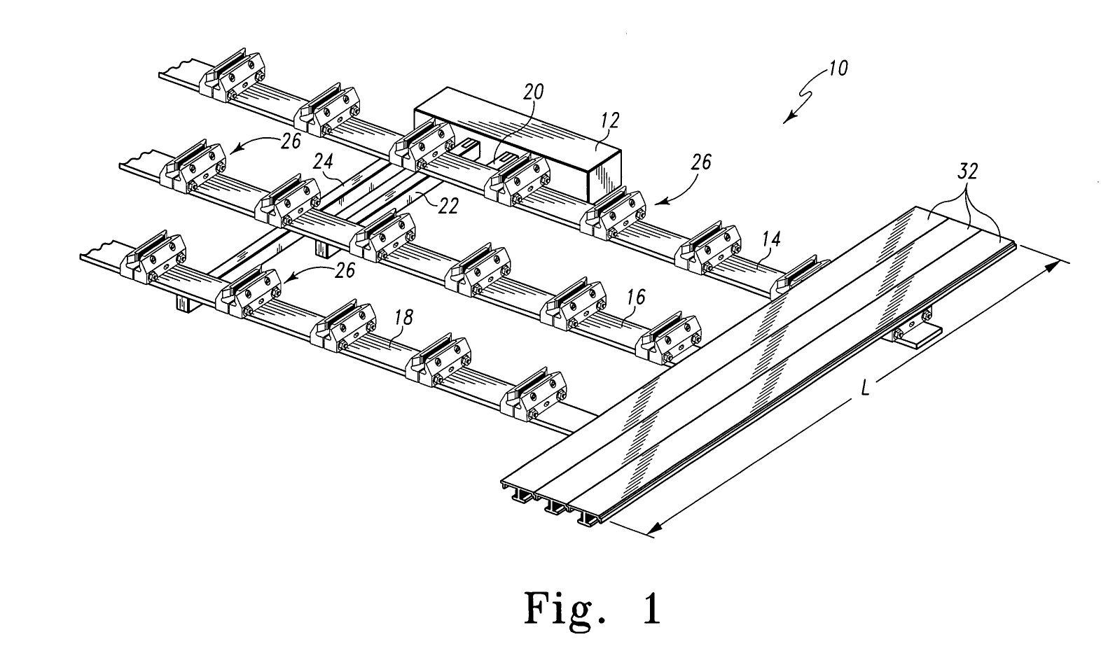

Referring now to FIG. 1, there is shown a moving floor apparatus 10 which may be used to move cargo in, for example, a cargo truck or trailer. The moving floor apparatus includes a drive actuator 12 which drives a number of drive beams 14, 16, 18. In the exemplary embodiment of the moving floor apparatus 10 described herein, the drive actuator 12 includes three independently-controlled hydraulic cylinders (not shown). The rod of one of the cylinders is coupled to one end of a link 20, with the other end of the link 20 being coupled to the drive beam 14. The rod of another one of the cylinders is coupled to one end of a link 22, with the other end of the link 22 being coupled to the drive beam 16. Similarly, the rod of the remaining cylinder is coupled to an end of a link 24, with the other end of the link 24 being coupled to the drive beam 18. It should be appreciated that the drive actuator may be embodied with any number of hydraulic cylinders for driving any number of drive beams with the embodiment described herein being exemplary in nature.

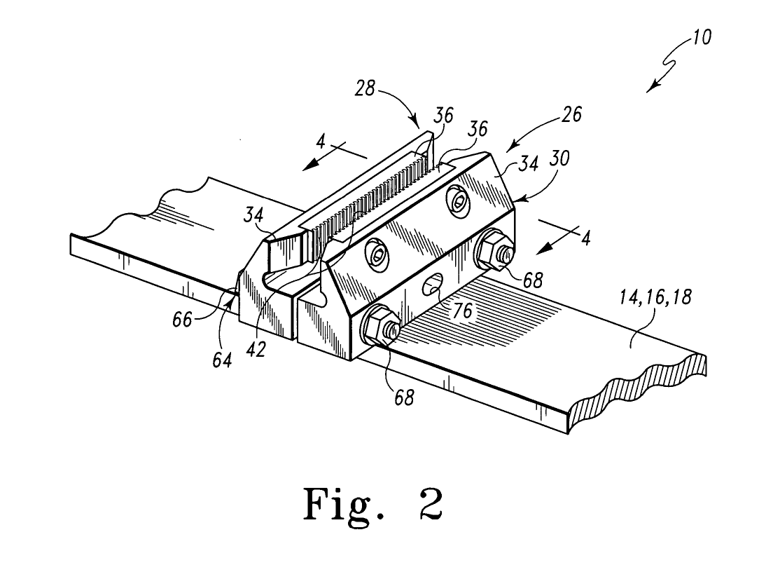

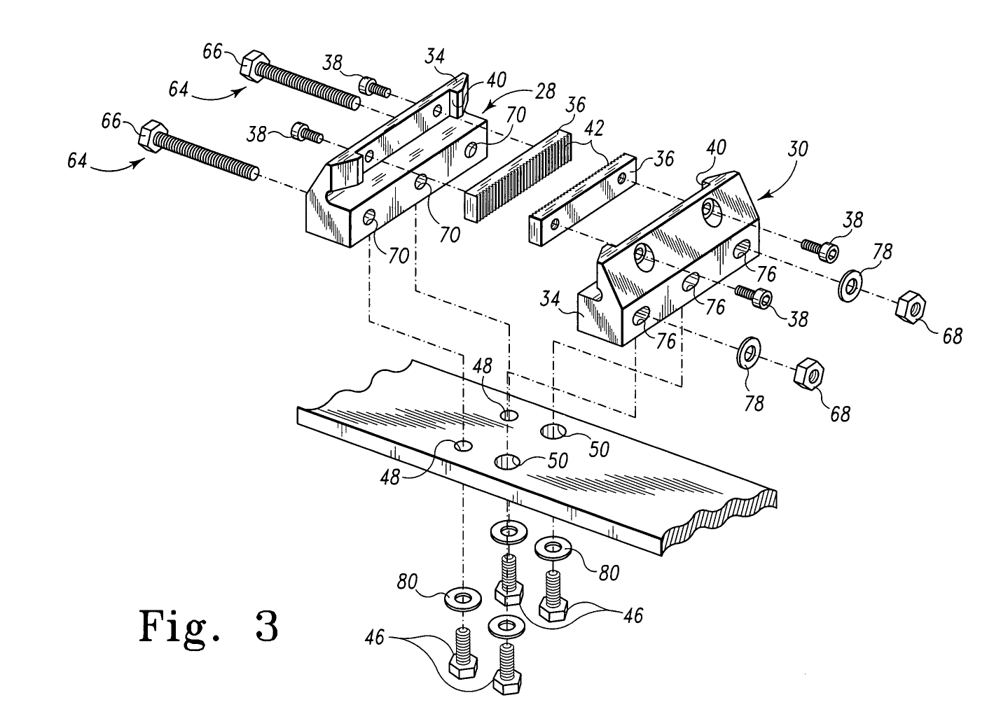

Each of the drive beams 14, 16, 18 has a number of clamp assemblies 26 coupled thereto. As shown in FIGS. 2-4, each of the clamp assemblies includes a pair of clamp blocks 28, 30 which clamp one of the floor slats 32 therebetween. In the exemplary embodiment described herein, each of the clamp blocks 28, 30 includes an aluminum body 34 having a removable steel plate or insert 36 secured thereto by use of a number fasteners such as screws 38. As shown in FIG. 3, the inserts 36 are received into a recess 40 formed in the body 34 of the clamp block 28, 30. It should be appreciated that although the body 34 and the insert 36 of the clamp blocks 28, 30 are shown as separate components, one-piece clamp blocks may be used.

Each of the inserts 36 has a knurled surface 42 defined therein. As will be described in greater detail below, the knurled surface 42 of the clamp blocks 28, 30 engages a knurled surface of the floor slats 32.

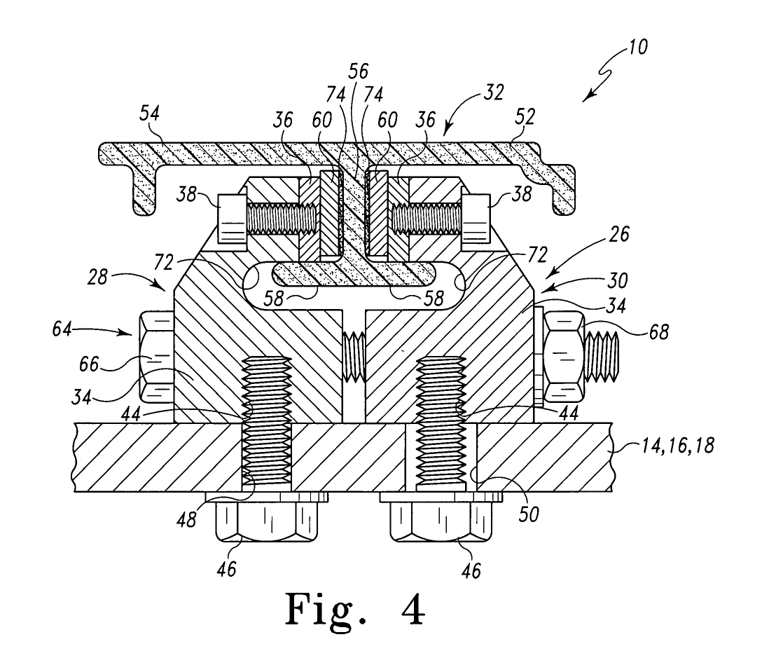

The clamp blocks 28, 30 are secured directly to the drive beams 14, 16, 18. As shown in FIG. 4, each of the clamp blocks 28, 30 has a number of threaded bores 44 defined therein. A fastener such as a bolt 46 is driven into each of the threaded bores 44 to couple the clamp block 28, 30 to the drive beam 14, 16, 18. One or more washers 80 may be used in conjunction with the bolts 46. As shown in FIGS. 3 and 4, a first pair of holes 48 and second pair of holes 50 are defined in the drive beams 14, 16, 18 to facilitate installation of the clamp blocks 28, 30, respectively. Specifically, one of the bolts 46 is advanced through each of the holes 48 and thereafter threaded into one of the threaded bores 44 of the clamp block 28 thereby coupling the clamp block 28 to the drive beam 14, 16, 18. Similarly, one of the bolts 46 is advanced through each of the holes 50 and thereafter threaded into one of the threaded bores 44 of the clamp block 30 thereby coupling the clamp block 30 to the drive beam 14, 16, 18. As shown in FIGS. 3 and 4, the inner diameter of the holes 48 closely matches the outer diameter of the threaded shaft of the bolts 46, whereas the inner diameter of the holes 50 is somewhat larger than the outer diameter of the threaded shaft of the bolts 46. As such, the clamp block 28 is stationary when secured to the drive beams 14, 16, 18, whereas the clamp block 30 is movable relative to the drive beam 14, 16, 18.

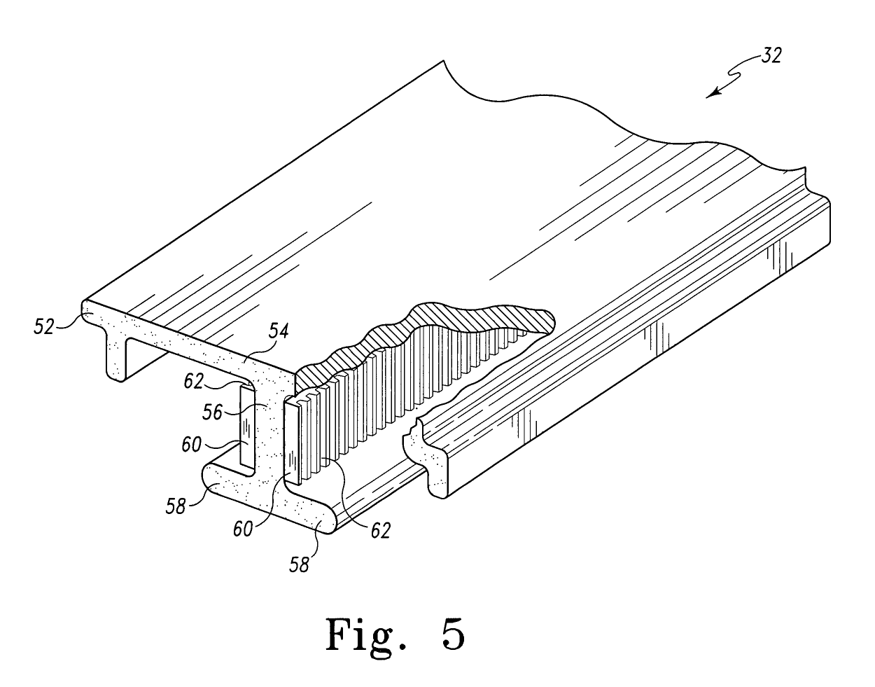

Referring now to FIG. 5, the floor slat 32 is shown in greater detail. The floor slat 32 includes a T-shaped slat body 52 having a substantially planar upper deck 54. A flange 56 extends downwardly from the bottom surface of the upper deck 54. A pair of wings 58 extend outwardly from the outer surfaces of the flange 56. The slat body 52 is pultruded or otherwise constructed with a glass fiber reinforced polymer (e.g., a glass fiber reinforced plastic), although other materials may be used.

A steel plate or insert 60 is secured to each side of the flange 56 by the use of, for example, an adhesive 74 (see FIG. 4). The steel inserts 60 have a knurled surface 62 defined in the outer surface thereof. The knurled surfaces 42 of the clamp blocks 28, 30 engage the knurled surfaces 62 of the floor slat 32 when the slat 32 is clamped by the clamp assembly 26 (see FIG. 4). It should be appreciated that although the body 52 and the insert 60 of the floor slat 32 are shown as separate components, one-piece floor slats may be used.

As shown in FIG. 3, a fastener 64 couples the clamp blocks 28, 30 to one another. Tightening of the fastener 64 causes the movable clamp block 30 to be urged toward the stationary clamp block 28 thereby exerting a clamping force on the flange 56 of the floor slat 32. In the exemplary embodiment described herein, the fastener 64 is embodied as a bolt 66 and a nut 68. The shaft of the bolt 66 extends through an opening 70 in the clamp block 28 and an opening 76 in the clamp block 30. The nut 68 is threaded on the end of the bolt shaft extending out of the opening 76. As shown in FIG. 3, a washer 78 may be used in conjunction with the nut 68. Rotation of the bolt 66 or the nut 68 (or both) in the appropriate direction urges the movable clamp block 30 toward the stationary clamp block 28 thereby exerting a clamping force on the flange 56 of the floor slat 32.

As shown in FIG. 3, in the exemplary embodiment described herein, the openings 76 of the movable clamp block 30 are embodied as somewhat elongated slots, whereas the openings 70 in the clamp block 28 are embodied as holes which have an inner diameter that closely matches the outer diameter of the threaded shaft of the bolts 66. As such, the stationary clamp block 28 is stationary relative to the bolt 66, whereas the movable clamp block 30 is movable relative to the bolt 66.

As shown in FIG. 1, each of the floor slats 32 has length L which corresponds to its long dimension. The fastener 64 extends between the clamp blocks 28, 30 in a direction that is substantially perpendicular to the length L of the floor slats 32. In the specific case of where the fastener 64 is embodied as a bolt (with or without a nut), the shaft of the bolt extends in a direction which is substantially perpendicular to the length L of the floor slat 32 that is clamped in the clamp assembly 26.

Although the fastener 64 is embodied as a bolt and nut in the exemplary embodiments described herein, it should be appreciated that the fastener 64 may be embodied as any type of fastener that couples the clamp blocks 28, 30. For example, the fastener 64 may be embodied as bolts or screws that are threaded into bores in the stationary clamp block 28. The fastener 64 may be embodied as C-clamps, strap clamps, or any other clamping device. In addition to these specific examples, numerous other types of fasteners may also be used.

To couple one of the slats 32 to one of the drive beams 14, 16, 18, an end of the slat 32 is first slid into one of the clamp assemblies 26 coupled to the particular drive beam 14, 16, 18. In doing so, the slat 32 is aligned with the clamp assembly 26 such that (i) the wings 58 of the slat are received into corresponding recesses 72 defined in the clamp blocks 28, 30 (see FIG. 4), (ii) the flange 56 of the slat 32 (including the inserts 62) is positioned between the inserts 36 of the clamp blocks 28, 30, and (iii) the lower surface of the upper deck is positioned above the upper surface of the clamp blocks 28, 30.

Once the slat 32 is slid into the clamp assembly 26, the fastener 64 is tightened. In the case of where the fastener 64 is embodied as the bolt 66 and nut 68, one or both of the bolt 66 and nut 68 may be rotated in the appropriate direction to cause the movable clamp block 30 to be urged toward the stationary clamp block 28 and into contact with the floor slat 32. Such movement of the clamp block 30 causes the knurled surface 42 of the clamp block 30 and the corresponding knurled surface 62 of the floor slat 32 to engage one another. Such movement of the clamp block 30 also causes the knurled surface 42 of the clamp block 28 and the corresponding knurled surface 62 of the floor slat 32 to engage one another. The clamp blocks 28, 30 exert a clamping force on the floor slat 32 when operated in such a manner thereby coupling the floor slat 32 to the drive beam 14, 16, 18. Once the fasteners 64 have been tightened, the bolts 46 threaded into the movable clamp block 30 may also be tightened.

To remove one of the floor slats 32 from one of the drive beams 14, 16, 18, the fasteners 64 of the clamp assembly 26 in which the floor slat 32 is clamped are first loosened. In the case of where each of the fasteners 64 are embodied as a bolt 66 and a nut 68, one or both of the bolt 66 and nut 68 may be rotated in the appropriate direction to cause the nut 68 to be moved in a direction away from head of the bolt 66. Either before or after the fasteners 64 are loosened, the bolts 46 threaded into the movable clamp block 30 may also be loosened. Such loosening of the fastener 64 and the bolts 46 permits the movable clamp block 30 to be moved in a direction away from the stationary clamp block 28. Such movement of the clamp block 30 causes the knurled surface 42 of the clamp block 30 and the corresponding knurled surface 62 of the floor slat 32 to disengage one another. Such movement of the clamp block 30 also allows the floor slat 32 to be moved relative to the stationary clamp block 28 thereby allowing the knurled surface 42 of the clamp block 28 and the corresponding knurled surface 62 of the floor slat 32 to be disengaged from one another. The floor slat 32 may then be slid out of the clamp assembly 26. If desired, a replacement floor slat 32 may be installed in the clamp assembly 26 in the manner described above.

While the disclosure is susceptible to various modifications and alternative forms, specific exemplary embodiments thereof have been shown by way of example in the drawings and have herein been described in detail. It should be understood, however, that there is no intent to limit the disclosure to the particular forms disclosed, but on the contrary, the intention is to cover all modifications, equivalents, and alternatives falling within the spirit and scope of the invention as defined by the appended claims.

For example, although the surfaces of the inserts 36 and 60 are herein described as being knurled, it should be appreciated that numerous other surface textures are also contemplated. For example, the clamp blocks 28, 30 and/or the floor slats 32 may be embodied with a roughened surface, gritty surface, or any other textured surface which enhances gripping between the components. Moreover, in some embodiments, the clamp blocks 28, 30 and/or the floor slats 32 may be embodied without a textured surface of any type.

Moreover, although the clamp block 28 and the clamp block 30 are herein embodied as being somewhat similar to one another, it should be appreciated that the clamp blocks 28 and 30 may be embodied as blocks having significantly different geometries and/or configurations.

There are a plurality of advantages of the present disclosure arising from the various features of the apparatus and methods described herein. It will be noted that alternative embodiments of the apparatus and methods of the present disclosure may not include all of the features described yet still benefit from at least some of the advantages of such features. Those of ordinary skill in the art may readily devise their own implementations of an apparatus and method that incorporate one or more of the features of the present disclosure and fall within the spirit and scope of the present disclosure.

1. An apparatus for securing a floor slat as part of a moving floor, the apparatus comprising:
a first clamp block having a first opening,
a second clamp block having a second opening, and
a fastener having a first portion positioned in the first opening and a second portion positioned in the second opening,
wherein (i) the floor slat has an upper deck with at least one flange extending downwardly therefrom, and (ii) the first clamp block and the second clamp block are configured to clamp the flange of the floor slat therebetween.

2. The apparatus of claim 1, wherein both the first clamp block and the second clamp block are secured directly to a drive beam.

3. The apparatus of claim 1, wherein at least one of the first clamp block and the second clamp block is movable relative to a drive beam.

4. The apparatus of claim 1, wherein:
the fastener comprises a bolt and a nut, and
movement of at least one of the bolt and the nut relative to the other causes at least one of the first clamp block and the second clamp block to be moved relative to the other.

5. (canceled)

6. The apparatus of claim 1, wherein the first clamp block has a knurled surface configured to engage a knurled surface of the floor slat.

7. The apparatus of claim 1, wherein both the first clamp block and the second clamp block have a knurled surface.

8. The apparatus of claim 7, wherein the floor slat has a knurled surface.

9. The apparatus of claim 7, wherein both the knurled surface of the first clamp block and the knurled surface of the second clamp block engage the floor slat when the fastener is tightened.

10. The apparatus of claim 9, wherein:
a first side of the flange has a first knurled surface,
a second side of the flange has a second knurled surface, and
the knurled surface of the first clamp block engages the first knurled surface of the flange and the knurled surface of the second clamp block engages the second knurled surface of the flange when the fastener is tightened.

11. The apparatus of claim 1, wherein:
the fastener comprises a bolt, and
rotation of the bolt causes at least one of the first clamp block and the second clamp block to be moved relative to the other.

12. An apparatus for securing a floor slat as part of a moving floor, the apparatus comprising:
a first clamp block having a first knurled surface, and
a second clamp block having a second knurled surface, the first knurled surface and the second knurled surface being movable relative to the other, wherein (i) the floor slat has an upper deck with at least one flange extending downwardly therefrom, and (ii) the first clamp block and the second clamp block are configured to clamp the flange therebetween.

13. The apparatus of claim 12, wherein at least one of the first clamp block and the second clamp block is movable relative to the other.

14. The apparatus of claim 12, wherein both the first clamp block and the second clamp block are secured to a drive beam.

15. The apparatus of claim 12, wherein at least one of the first clamp block and the second clamp block is movable relative to the drive beam.

16. The apparatus of claim 12, further comprising a fastener, wherein movement of the fastener causes at least one of the first knurled surface and the second knurled surface to be moved relative to the other.

17. The apparatus of claim 16, wherein:
the fastener comprises a bolt and a nut, and
movement of at least one of the bolt and the nut relative to the other causes at least one of the first knurled surface and the second knurled surface to be moved relative to the other.

18. (canceled)

19. The apparatus of claim 12, wherein:
the flange of the floor slat has first knurled surface and a second knurled surface, and
the knurled surface of the first clamp block engages the first knurled surface of the flange of the floor slat and the knurled surface of the second clamp block engages the second knurled surface of the flange of the floor slat when the flange of the floor slat is clamped between the first clamp block and the second clamp block.

20. The apparatus of claim 16, wherein:
the fastener comprises a bolt, and
rotation of the bolt causes at least one of the first clamp block and the second clamp block to be moved relative to the other.

21. A moving floor apparatus, comprising:
a drive beam,
a clamp assembly coupled to the drive beam, the clamp assembly having (i) a first clamp block having a first opening defined therein, (ii) a second clamp block having a second opening defined therein, and (iii) a fastener having a first portion positioned in the first opening and a second portion positioned in the second opening, and
a floor slat coupled to the clamp assembly, wherein (i) the floor slat has an upper deck with at least one flange extending downwardly therefrom, and (ii) the flange of the floor slat is clamped between the first clamp block and the second clamp block.

22. The apparatus of claim 21, wherein at least one of the first clamp block and the second clamp block is movable relative to the drive beam.

23. The apparatus of claim 21, wherein:
the fastener comprises a bolt and a nut, and
movement of at least one of the bolt and the nut relative to the other causes at least one of the first clamp block and the second clamp block to be moved relative to the drive beam.

24. (canceled)

25. The apparatus of claim 21, wherein:
the floor slat has a first knurled surface and second knurled surface,
the first clamp block has a knurled surface engaged with the first knurled surface of the floor slat, and
the second clamp block has a knurled surface engaged with the second knurled surface of the floor slat.

26. The apparatus of claim 21, further comprising a drive actuator coupled to the drive beam, wherein actuation of the drive actuator causes movement of the drive beam.

27. The apparatus of claim 26, wherein the drive actuator comprises a hydraulic cylinder coupled to the drive beam.

28. The apparatus of claim 21, wherein:
the fastener comprises a bolt, and
rotation of the bolt causes at least one of the first clamp block and the second clamp block to be moved relative to the other.

29. A moving floor apparatus, comprising:
a drive beam,
a clamp assembly coupled to the drive beam, the clamp assembly having (i) a first clamp block having a first knurled surface, and (ii) a second clamp block having a second knurled surface, at least one of the first knurled surface and the second knurled surface being movable relative to the drive beam, and
a floor slat having an upper deck with at least one flange extending downwardly therefrom, wherein the flange of the floor slat is clamped between the knurled surface of the first clamp block and the knurled surface of the second clamp block.

30. The apparatus of claim 29, wherein at least one of the first clamp block and the second clamp block is movable relative to the drive beam.

31. The apparatus of claim 29, wherein:
the clamp assembly further comprises a fastener, and
movement of the fastener causes at least one of the first knurled surface and the second knurled surface to be moved relative to the other.

32. The apparatus of claim 31, wherein:
the fastener comprises a bolt and a nut, and
movement of at least one of the bolt and the nut relative to the other causes at least one of the first knurled surface and the second knurled surface to be moved relative to the other.

33. (canceled)

34. The apparatus of claim 29, wherein the flange of the floor slat has (i) a first knurled surface engaged with the knurled surface of the first clamp block and, (ii) a second knurled surface engaged with the knurled surface of the second clamp block.

35. The apparatus of claim 29, fiber comprising a drive actuator coupled to the drive beam, wherein actuation of the drive actuator causes movement of the drive beam.

36. The apparatus of claim 35, wherein the drive actuator comprises a hydraulic cylinder coupled to the drive beam.

37. The apparatus of claim 31, wherein:
the fastener comprises a bolt, and
rotation of the bolt causes at least one of the first clamp block and the second clamp block to be moved relative to the other.

38. An apparatus for securing a floor slat as part of a moving floor, the apparatus comprising:
a first clamp block,
a second clamp block, and
a fastener extending between the first clamp block and the second clamp block in a direction which is substantially perpendicular to the length of the floor slat when the floor slat is clamped between the first clamp block and the second clamp block,
wherein (i) the floor slat has an upper deck with at least one flange extending downwardly therefrom, and (ii) the first clamp block and the second clamp block are configured to clamp the flange of the floor slat therebetween.

39. The apparatus of claim 38, wherein both the first clamp block and the second clamp block are secured directly to a drive beam.

40. The apparatus of claim 39, wherein at least one of the first clamp block and the second clamp block is movable relative to a drive beam.

41. The apparatus of claim 39; wherein:
the fastener comprises a bolt and a nut, and
movement of at least one of the bolt and the nut relative to the other causes at least one of the first clamp block and the second clamp block to be moved relative to the other.

42. (canceled)

43. The apparatus of claim 39, wherein the first clamp block has a knurled surface configured to engage a knurled surface of the floor slat.

44. The apparatus of claim 39, wherein both the first clamp block and the second clamp block have a knurled surface.

45. The apparatus of claim 44, wherein the floor slat has a knurled surface.

46. The apparatus of claim 44, wherein both the knurled surface of the first clamp block and the knurled surface of the second clamp block engage the floor slat when the fastener is tightened.

47. The apparatus of claim 46, wherein:
a first side of the flange has a first knurled surface,
a second side of the flange has a second knurled surface, and
the knurled surface of the first clamp block engages the first knurled surface of the flange and the knurled surface of the second clamp block engages the second knurled surface of the flange when the fastener is tightened.

48. The apparatus of claim 38, wherein:
the fastener comprises a bolt, and
rotation of the bolt causes at least one of the first clamp block and the second clamp block to be moved relative to the other.

49. A moving floor apparatus, comprising:
a floor slat,
a drive beam,
a clamp assembly coupled to the drive beam and having the floor slat clamped therein, the clamp assembly having (i) a first clamp block, (ii) a second clamp block, and (iii) a fastener extending between the first clamp block and the second clamp block in a direction which is substantially perpendicular to the length of the floor slat,
wherein (i) the floor slat has an upper deck with a at least one flange extending downwardly therefrom, and (ii) the flange of the floor slat is clamped between the first clamp block and the second clamp block.

50. The apparatus of claim 49, wherein at least one of the first clamp block and the second clamp block is movable relative to the drive beam.

51. The apparatus of claim 49, wherein:
the fastener comprises a bolt and a nut, and
movement of at least one of the bolt and the nut relative to the other causes at least one of the first clamp block and the second clamp block to be moved relative to the drive beam.

52. (canceled)

53. The apparatus of claim 49, wherein:
the floor slat has a first knurled surface and second knurled surface,
the first clamp block has a knurled surface engaged with the first knurled surface of the floor slat, and
the second clamp block has a knurled surface engaged with the second knurled surface of the floor slat.

54. The apparatus of claim 49, further comprising a drive actuator coupled to the drive beam, wherein actuation of the drive actuator causes movement of the drive beam.

55. The apparatus of claim 49, wherein the drive actuator comprises a hydraulic cylinder coupled to the drive beam.

56. The apparatus of claim 49, wherein:
the fastener comprises a bolt, and
rotation of the bolt causes at least one of the first clamp block and the second clamp block to be moved relative to the other.

57. A method of securing a floor slat to a drive beam of a moving floor, the method comprising the steps of:
positioning a downwardly extending flange of a floor slat between a first clamp block and a second clamp block,
positioning a first portion of a fastener in an opening of the first clamp block and a second portion of the fastener in the an opening of the second clamp block, and
tightening the fastener to urge the first clamp block and the second clamp block toward one another thereby clamping the flange of the floor slat between the first clamp block and the second clamp block.

58. The method of claim 57, wherein the tightening step comprises urging at least one of the first clamp block and the second clamp block into contact with the portion of the floor slat.

59. (canceled)

60. The method of claim 57, wherein:
the first clamp block has a knurled surface,
the flange of the floor slat has a knurled surface, and
the tightening step comprises urging the knurled surface of the first clamp block and the knurled surface of the flange into contact with one another.

61. The method of claim 57, wherein:
both the first clamp block and the second clamp black have a knurled surface,
the flange of the floor slat has a first knurled surface and a second knurled surface, and
the tightening step comprises (i) urging the knurled surface of the first clamp block and the first knurled surface of the flange into contact with one another, and (ii) urging the knurled surface of the second clamp block and the second knurled surface of the flange into contact with one another.

62. The method of claim 57, wherein:
the fastener comprises a bolt and a nut, and
the tightening step comprises moving at least one of the bolt and the nut relative to the other.

63. The method of claim 57, wherein:
at least one of the first clamp block and the second clamp block is movable relative to the drive beam, and
the tightening step comprises moving at least one of the first clamp block and the second clamp block toward the other.

64. The method of claim 57, wherein:
the fastener comprises a bolt, and
the tightening step comprises rotating the bolt to urge the first clamp block and the second clamp block toward one another.

65. An apparatus for securing a floor slat as part of a moving floor, the apparatus comprising:
a first clamp block having a first textured surface, and
a second clamp block having a second textured surface, the first textured surface and the second textured surface being movable relative to the other,
wherein (i) the floor slat has an upper deck with at least one flange extending downwardly therefrom, and (ii) the first clamp block and the second clamp block are configured to clamp the flange of the floor slat therebetween.

66. The apparatus of claim 65, wherein at least one of the first clamp block and the second clamp block is movable relative to the other.

67. The apparatus of claim 65, wherein both the first clamp block and the second clamp block are secured to a drive beam.

68. The apparatus of claim 65, wherein at least one of the first clamp block and the second clamp block is movable relative to the drive beam.

69. The apparatus of claim 65, further comprising a fastener, wherein movement of the fastener causes at least one of the first textured surface and the second textured surface to be moved relative to the other.

70. The apparatus of claim 69, wherein:
the fastener comprises a bolt and a nut, and
movement of at least one of the bolt and the nut relative to the other causes at least one of the first textured surface and the second textured surface to be moved relative to the other.

71. (canceled)

72. The apparatus of claim 65, wherein:
the flange of the floor slat has first textured surface and a second textured surface, and
the first textured surface of the first clamp block engages the first textured surface of the flange of the floor slat and the second textured surface of the second clamp block engages the second textured surface of the flange of the floor slat when the flange of the floor slat is clamped between the first clamp block and the second clamp block.

73. The apparatus of claim 65, wherein each of the first textured surface and the second textured surface comprises a roughened surface.

74. The apparatus of claim 65, wherein each of the first textured surface and the second textured surface comprises a gritty surface.

75. The apparatus of claim 65, wherein each of the first textured surface and the second textured surface comprises a knurled surface.

76. A floor slat of a moving floor, comprising:
a slat body constructed of a fiber reinforced polymer, the slat body having an upper deck and a flange extending downwardly from the upper deck, wherein the flange has a first side having a first textured surface and a second, opposite side having a second textured surface,
a first insert secured to the first side of the flange, the first textured surface being defined in the first insert, and
a second insert secured to the second side of the flange, the second textured surface being defined in the second insert.

77. (canceled)

78. The floor slat of claim 76, wherein both the first textured surface and the second textured surface comprises a knurled surface.

79. The floor slat of claim 76, wherein both the first textured surface and the second textured surface comprises a roughened surface.

80. The floor slat of claim 76, wherein both the first textured surface and the second textured surface comprises a gritty surface.
